(19) United States
(12) Patent Application Publication
(10) Pub. No.: US 2005/0282043 A1
(43) Pub. Date: Dec. 22, 2005

(54) Hexagonal ferrite magnetic powder, process for producing the same, and magnetic recording medium

(75) Inventors: Nobuo Yamazaki, Kanagawa (JP); Masatoshi Takahashi, Kanagawa (JP); Akira Manabe, Shizuoka (JP); Hiroyuki Suzuki, Shizuoka (JP)

Correspondence Address: SUGHRUE MION, PLLC, 2100 PENNSYLVANIA AVENUE, N.W., SUITE 800, WASHINGTON, DC, 20037, US

(73) Assignees: FUJI PHOTO FILM CO., LTD.; ASAHI TECHNO GLASS CORPORATION

(21) Appl. No.: 11/156,654

(22) Filed: Jun. 21, 2005

(30) Foreign Application Priority Data
Jun. 21, 2004 (JP) P. 2004-182593

(51) Int. Cl. H01F 1/00; C01G 49/00; G11B 5/708

(52) U.S. Cl. 428/842.8; 252/62.63; 252/62.6; 252/62.59; 252/62.62; 252/62.57; 423/138

(57) ABSTRACT

A hexagonal ferrite magnetic powder having an average tabular diameter of from 15 to 30 nm, an average tabular ratio of from 3.0 to 4.9, an Hc of from 2,020 to 5,000 Oe (from 161.6 to 400 kA/m) and an SFD of from 0.3 to 0.7, and comprising at least one tetravalent element in a proportion of from 0.004 to 0.045 atoms based on one atom of Fe.

### FIELD OF THE INVENTION

The present invention relates to a hexagonal ferrite magnetic powder, a process for producing the same, and a magnetic recording medium. In more detail, the invention relates to a hexagonal ferrite magnetic powder suitable for a magnetic recording medium for high-density recording, which can realize satisfactory output characteristics and a low noise and which is reproduced by a high-sensitivity head such as MR heads and GMR heads, and to a process for producing the same. Furthermore, the invention relates to a magnetic recording medium having the subject hexagonal ferrite magnetic powder in a magnetic powder.

### BACKGROUND OF THE INVENTION

In the magnetic recording field, a magnetic head replying upon electromagnetic induction as an operation principle (induction type magnetic head) has been employed and become widespread. However, in using the induction type magnetic head in a recording/reproducing region with higher density as currently required, limits start to be seen. That is, in order to obtain a large reproducing output, it is necessary to increase the number of turns of coil of a reproducing head. However, in this case, the inductance increases, and the resistance at a high frequency increases. As a result, there is encountered a problem that the reproducing output is lowered. Then, in recent years, a reproducing head replying upon MR (magnetic resistance) as an operation principle is proposed and starts to be used in hard disks and the like. According to an MR head, a reproducing output of several times is obtained as compared with the induction type magnetic head. Also, since the MR head does not use an induction coil, an instrument noise such as an impedance noise is largely reduced. Accordingly, it becomes possible to obtain a large SN ratio.

On the other hand, an enhancement of high-density recording characteristics is also achieved by minimizing a noise of the magnetic recording medium which has hitherto been hided by the instrument noise.

For achieving such an object, for example, there is proposed a magnetic recording medium comprising a non-magnetic support having provided thereon a magnetic layer having a hexagonal ferrite magnetic powder dispersed in a binder (for example, JP-A-10-312525).

Furthermore, improvements of a hexagonal ferrite magnetic powder are disclosed in JP-A-64-42104, JP-A-3-79001, JP-A-6-77036 and JP-A-63-55122.

However, according to the foregoing related-art technologies, it was impossible to obtain a magnetic recording medium for high-density recording of up to 1 Gbpsi as currently required.

In order to enhance the recording density of the magnetic recording medium, a high SN ratio is necessary. In general, it is known to set up an Hc high for the purpose of suppressing recording demagnetization and self demagnetization in short-wavelength recording and to design the particle size of a magnetic powder as small as possible for the purpose of suppressing a noise. In order to make the Hc high, in the case of a hexagonal ferrite, it is employed to minimize an element for substituting a part of Fe.

Furthermore, in order to make the particle finer, in the case of a hexagonal ferrite, it is necessary to suppress the crystal growth of the particle so that the crystallization temperature is set up low. If these magnetic powders are prepared within the conventional findings, there appears a phenomenon in which SFD becomes large due to the formation of a fine particle so that when formed into a medium, an output does not become sufficiently high because of a potential influence of self demagnetization. Moreover, if only an amount of the substituent element is reduced, though the Hc becomes high, a tabular ratio of the particle increases. If the tabular ratio increases, there appears a phenomenon in which a packing density of the hexagonal ferrite particle in the magnetic layer of the magnetic recording medium is lowered, and coagulation called stacking among the particles due to an increase of the tabular ratio is generated to increase a noise. As a result, a sufficient performance as a magnetic recording medium for high-density recording was not obtained.

### SUMMARY OF THE INVENTION

An object of the invention is to provide a hexagonal ferrite magnetic powder suitable for a magnetic recording medium for high-density recording, which can realize satisfactory output characteristics and a low noise and which is reproduced by a high sensitivity head such as MR heads and GMR heads, a process for producing the same, and a magnetic recording medium.

The invention is as follows.

(1) A hexagonal ferrite magnetic powder having an average tabular diameter of from 15 to 30 nm, an average tabular ratio of from 3.0 to 4.9, an Hc of from 2,020 to 5,000 Oe (from 161.6 to 400 kA/m), and an SFD of from 0.3 to 0.7 and containing at least one tetravalent element (M4) in a proportion of from 0.004 to 0.045 atoms based on one atom of Fe.

(2) The hexagonal ferrite magnetic powder as set forth above in (1), wherein the tetravalent element (M4) is at least one member selected from the group consisting of Ti, Mn, Zr, Sn, Hf, Ir, Ce, and Pb.

(3) The hexagonal ferrite magnetic powder as set forth above in (1), containing at least one divalent element (M2) selected from the group consisting of Mg, Co, Ni, Cu, Zn, Pd, and Cd in a proportion of from 0.004 to 0.045 atoms based on one atom of Fe.

(4) A process for producing a hexagonal ferrite magnetic powder as set forth above in (1), which comprises a step of mixing a hexagonal ferrite forming raw material with at least one tetravalent element (M4) in a proportion of from 0.004 to 0.045 atoms based on one atom of Fe to be contained in the hexagonal ferrite forming raw material, melting the resuiting raw material mixture, and quenching the molten-mixture to obtain an amorphous material; and a step of subsequently thermally treating the amorphous material to deposit a hexagonal ferrite.

(5) The process for producing a hexagonal ferrite magnetic powder as set forth above in (4), wherein the tetravalent element (M4) is at least one member selected from the group consisting of Ti, Mn, Zr, Sn, Hf, Ir, Ce, and Pb.

(6) A magnetic recording medium comprising a non-magnetic support having provided thereon a magnetic layer having a hexagonal ferrite magnetic powder dispersed in a binder, wherein the hexagonal ferrite magnetic powder is the hexagonal ferrite magnetic powder as set forth above in any one of (1) to (3).

(7) The magnetic recording medium as set forth above in (6), wherein a non-magnetic layer having a non-magnetic powder dispersed in a binder is provided between the non-magnetic support and the magnetic layer.

According to the invention, by specifying an average tabular ratio and adding a specific amount of a tetravalent element (M4), even when a hexagonal ferrite magnetic powder is made fine, not only an increase of SFD is suppressed, but also satisfactory output characteristics and a low noise can be realized. Accordingly, there are provided a hexagonal ferrite magnetic powder suitable for a magnetic recording medium for high-density recording, which is reproduced by a high-sensitivity head such as MR heads and GMR heads, a process for producing the same, and a magnetic recording medium.

### BRIEF DESCRIPTION OF THE DRAWINGS

FIG. 1 is a triangular phase diagram according to the invention, in which AO, B₂O₃, and Fe₂O₃ are the apexes.

### DETAILED DESCRIPTION OF THE INVENTION

The invention will be described below in more detail.

A hexagonal ferrite magnetic powder of the invention has an average tabular diameter of from 15 to 30 nm, and preferably from 18 to 28 nm; an average tabular ratio of from 3.0 to 4.9, and preferably from 3.0 to 4.2; a coercive force Hc of from 2,020 to 5,000 Oe (from 161.6 to 400 kA/m), and preferably from 2,100 to 4,200 Oe (from 168 to 336 kA/m); and a switching field distribution SFD of from 0.3 to 0.7, and preferably from 0.3 to 0.6. When the average tabular diameter is less than 15 nm, sufficient magnetic characteristics are not obtained, while when it exceeds 30 nm, a noise becomes large, and an SN ratio necessary for a magnetic recording medium for high density recording cannot be ensured. When the average tabular ratio is less than 3.0, a balance of magnetic characteristics is not obtained, while when it exceeds 4.9, not only a packing ratio of the magnetic powder in the magnetic layer becomes low, but also a reduction of a noise due to stacking is seen. When the Hc is less than 2,020 Oe, a reduction of an output, which is considered to be caused due to self demagnetization of short-wavelength recording, is large. Furthermore, in the range of the average tabular diameter of from 15 to 30 nm, it is difficult to produce a magnetic powder having an Hc exceeding 5,000 Oe. Moreover, when the SFD exceeds 0.7, a reduction of the output is large. Incidentally, it is difficult to produce a magnetic powder having an SFD of less than 0.3.

Furthermore, it is necessary that the hexagonal ferrite magnetic powder of the invention contains at least one tetravalent element (M4) in a proportion of from 0.004 to 0.045 atoms, and from 0.010 to 0.035 atoms based on one atom of Fe. A preferred tetravalent element (M4) is at least one member selected from the group consisting of Ti, Mn, Zr, Sn, Hf, Ir, Ce, and Pb. Of these, Zr and Sn are especially preferable.

By adding such a tetravalent element (M4), it is possible to increase the average tabular ratio and to reduce the SFD while suppressing an increase of the noise. When the addition amount of the tetravalent element (M4) is less than 0.004 atoms, an increase of the average tabular ratio does not occur, and the SFD is not reduced. In contrast, when it exceeds 0.045 atoms, the average tabular ratio excessively increases so that a powder which is hardly dispersed is formed, whereby the medium characteristics become worse.

In addition, it is desired that the hexagonal ferrite magnetic powder of the invention contains at least one divalent element (M2) in a proportion of from 0.004 to 0.045 atoms, and preferably from 0.010 to 0.035 atoms based on one atom of Fe. By adding the divalent element (M2), it is possible to regulate the coercive force while suppressing an increase of the noise. Also, by making the addition amount of the divalent element (M2) fall within the foregoing range, it is possible to obtain a coercive force suitable for a magnetic recording medium for high-density recording.

A preferred divalent element (M2) is at least one member selected from the group consisting of Mg, Co, Ni, Cu, Zn, Pd, and Cd. Of these, Co and Zn are especially preferable. Incidentally, in the case where Co is chosen as the divalent element (M2), since an effect for reducing the coercive force is large, its addition amount is preferably from 0.004 to 0.030 atoms based one atom of Fe.

The hexagonal ferrite magnetic powder of the invention can be obtained by the following production process.

That is, hexagonal ferrite forming raw materials are mixed with the foregoing tetravalent element (M4) and optionally, the divalent element (M2); the resulting raw material mixture is melted; the molten mixture is quenched to obtain an amorphous material; and the amorphous material is subsequently thermally treated to deposit a hexagonal ferrite, thereby obtaining the hexagonal ferrite magnetic powder of the invention.

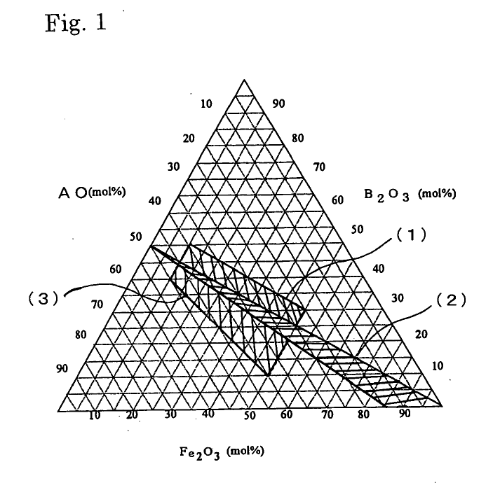

The hexagonal ferrite forming raw material is not particularly limited. For example, for the purpose of achieving high Hc and saturation magnetization as, raw materials falling within a composition region of slant line portions (1) to (3) in a triangular phase diagram as shown in FIG. 1, in which AO (wherein A represents at least one member selected from, for example, Ba, Sr, Ca, and Pb), B₂O₃, and Fe₂O₃ are the apexes, are preferable. Raw materials falling within a composition region surrounded by the following four points a, b, c and d (slant line portion (1)) are especially preferable.
(a) B₂O₃=50% by mole, AO=40% by mole, Fe₂O₃=10% by mole
(b) B₂O₃=45% by mole, AO=45% by mole, Fe₂O₃=10% by mole
(c) B₂O₃=25% by mole, AO=25% by mole, Fe₂O₃=50% by mole
(d) B₂O₃=30% by mole, AO=20% by mole, Fe₂O₃=50% by mole

Furthermore, in the hexagonal ferrite in the invention, a part of Fe may be substituted with at least one metal element. Examples of the substituent element include Co—Zn—Nb, Co—Ti, Co—Ti—Sn, Co—Sn—Nb, Co—Zn—Sn—Nb, Co—Zn—Zr—Nb, and Co—Zn—Mn—Nb. Incidentally, with respect to such a metal element, the selection, blending ratio and introduction amount may be properly determined adaptive with the necessary Hc.

The melting step of the raw materials is, for example, carried out at a temperature of from 1,250 to 1,450° C., and preferably from 1,300 to 1,400° C. The quenching step may be carried out by a known method, for example, roll quenching by pouring the molten material on water cooled double rolls as rotated at a high speed. Also, with respect to the conditions of the thermal treatment step of the resulting amorphous material, for example, the temperature is from 600 to 750° C., and preferably from 620 to 680° C.; and the retention time is from 2 to 12 hours, and preferably from 3 to 6 hours. Thereafter, an acid treatment is carried out under heating to remove an excessive glass component, and the residue is washed with water and dried to obtain the hexagonal ferrite magnetic powder of the invention.

It is desired that the hexagonal ferrite magnetic powder of the invention has a specific surface area in the range of from 45 to 80 m²/g in terms of a value as measured by the BET method. Also, if desired, the hexagonal ferrite magnetic powder of the invention may be subjected to a surface treatment with Al, Si, P, or an oxide or hydroxide thereof. Its amount is suitably from 0.1 to 10% by weight based on the magnetic powder.

Moreover, the invention is to provide a magnetic recording medium comprising a non-magnetic support having a magnetic layer provided thereon, wherein the magnetic layer is made of the hexagonal ferrite magnetic powder of the invention having been dispersed in a binder. The magnetic recording medium of the invention will be described below.

[Non-Magnetic Support]

As the support which is used in the invention, a flexible support is preferable. For example, known films such as polyesters (for example, polyethylene terephthalate (PET) and polyethylene naphthalate (PEN)), polyolefins, cellulose triacetate, polycarbonates, polyamides, polyimides, polyamideimides, polysulfones, and aromatic polyamides (for example, aramids) can be used. Such a support may be subjected to a corona discharge treatment, a plasma treatment, a treatment for enhancing adhesion, a thermal treatment, a dust removing treatment, etc. In order to achieve the object of the invention, it is preferred to use a support having a center line average surface roughness of usually not more than 0.03 μm, preferably not more than 0.02 μm, and more preferably not more than 0.01 μm. Also, in such a support, it is preferable that not only the center line average surface roughness is small, but also coarse projections of 1 μm or more are not contained. In addition, the shape of the surface roughness is freely controlled by the size and amount of a filler which is added in the support as the need arises. Examples of such a filler include oxides or carbonates of Ca, Si, Ti, etc. and organic fine powders such as acrylic resins.

[Magnetic Layer]

The binder which is used in the magnetic layer of the invention is a conventionally known thermoplastic resin, thermosetting resin or reaction type resin or a mixture thereof. Examples of the thermoplastic resin include polymers or copolymers containing, as a constituent unit, vinyl chloride, vinyl acetate, vinyl alcohol, maleic acid, acrylic acid, an acrylic ester, vinylidene chloride, acrylonitrile, methacrylic acid, a methacrylic ester, styrene, butadiene, ethylene, vinyl butyral, vinyl acetal, vinyl ether, or the like; polyurethane resins; and various rubber based resins.

Furthermore, examples of the thermosetting resin or reaction type resin include phenol resins, epoxy resins, polyurethane curable resins, urea resins, melamine resins, alkyd resins, acrylic reaction resins, formaldehyde resins, silicone resins, epoxy-polyamide resins, mixtures of a polyester resin and an isocyanate prepolymer, mixtures of a polyester polyol and a polyisocyanate, and mixtures of a polyurethane and a polyisocyanate. All of the thermoplastic resin, the thermosetting resin and the reaction type resin are described in detail in Purasuchikku Handobukku (Plastic Handbook) (published by Asakura Shoten).

Moreover, when an electron beam-curable resin is used in the magnetic layer, not only the coating film strength is enhanced and the durability is improved, but also the surface is smoothed and the electromagnetic conversion characteristics are further enhanced. Examples and production process thereof are described in detail in JP-A-62-256219.

These resins can be used singly or in an embodiment of a combination thereof. Above all, it is preferred to use a polyurethane resin. Moreover, it is preferred to use a polyurethane resin prepared by not only reacting hydrogenated bisphenol A or a cyclic structure such as a polypropylene oxide adduct of hydrogenated bisphenol A, a polyol having an alkylene oxide chain and having a molecular weight of from 500 to 5,000, a polyol having a cyclic structure and having a molecular weight of from 200 to 500 as a chain extender, and an organic diisocyanate but also introducing a polar group; a polyurethane resin prepared by not only reacting a polyester polyol composed of an aliphatic dibasic acid (for example, succinic acid, adipic acid, and sebacic acid) and an aliphaticdiol having an alkyl branched side chain and not having a cyclic structure (for example, 2,2-dimethyl-1,3-propanediol, 2-ethyl-2-butyl-1,3-propanediol, and 2,2-diethyl-1,3-propanediol), an aliphatic diol having a branched alkyl side chain having 3 or more carbon atoms (for example, 2-ethyl-2-butyl-1,3-propanediol and 2,2-diethyl-1,3-propanediol) as a chain extender, and an organic diisocyanate compound but also introducing a polar group; or a polyurethane resin prepared by not only reacting a cyclic structure such as a dimer diol, a polyol compound having a long-chain alkyl chain, and an organic diisocyanate but also introducing a polar group.

An average molecular weight of the polar group-containing polyurethane based resin which is used in the invention is preferably from 5,000 to 100,000, and more preferably from 10,000 to 50,000. What the average molecular weight is 5,000 or more is preferable because a reduction of physical strength such that the resulting magnetic coating film is brittle is not caused and the durability of the magnetic recording medium is not affected. Also, when the average molecular weight is not more than 100,000, since the solubility in a solvent is not lowered, the dispersibility is satisfactory. Moreover, since the viscosity of a coating material in a prescribed concentration does not increase, the workability is good, and the handling is easy.

Examples of the polar group which is contained in the foregoing polyurethane based resin include —COOM, —SO₃M, —OSO₃M, —P═O (OM)₂, —O—P═O (OM)₂ (wherein M represents a hydrogen atom or an alkali metal base), —OH, —NR₂, —N⁺R₃ (wherein R represents a hydrocarbon group), an epoxy group, —SH, and —CN; and those resulting from introduction of at least one of these polar groups by copolymerization or addition reaction can be used. Also, in the case where the polar group-containing polyurethane based resin has an OH group, it is preferred to have a branched OH group in view of curability and durability. The polar group-containing polyurethane based resin preferably has from 2 to 40 branched OH groups, and more preferably from 3 to 20 branched OH groups per molecule. Also, an amount of such a polar group is from 10⁻¹ to 10⁻⁸ moles/g, and preferably 10⁻² to 10⁻⁶ moles/g.

Specific examples of the binder include VAGH, VYHH, VMCH, VAGF, VAGD, VROH, VYES, VYNC, VMCC, XYHL, XYSG, PKHN, PKHJ, PKHC, and PKFE (all of which are manufactured by Union Carbide Corporation); MPR-TA, MPR-TA5, MPR-TAL, MPR-TSN, MPR-TMF, MPR-TS, MPR-TM, and MPR-TAO (all of which are manufactured by Nissin Chemical Industry Co., Ltd.); 1000W, DX80, DX81, DX82, DX83, and 100FD (all of which are manufactured by Denki Kagaku Kogyo K.K.); MR-104, MR-105, MR110, MR100, MR555, and 400X-110A (all of which are manufactured by Zeon Corporation); NIPPOLAN N2301, N₂₃O₂ and N₂₃O₄ (all of which are manufactured by Nippon Polyurethane Industry Co., Ltd.); PANDEX T-5105, R-R3080 and T-5201, BURNOCK D-400 and D-210-80, and CRISVON 6109 and 7209 (all of which are manufactured by Dainippon Ink and Chemicals, Incorporated); VYLON UR8200, UR8300, UR-8700, RV530 and RV280 (all of which are manufactured by Toyobo Co., Ltd.); DAIFERAMINE 4020, 5020, 5100, 5300, 9020, 9022 and 7020 (all of which are manufactured by Dainichiseika Color & Chemicals Mfg. Co., Ltd.); MX 5004 (manufactured by Mitsubishi Chemical Corporation); SANPRENE SP-150 (manufactured by Sanyo Chemical Industries, Ltd.); and SARAN F310 and F210 (all of which are manufactured by Asahi Kasei Corporation).

An addition amount of the binder which is used in the magnetic layer of the invention is in the range of from 5 to 50% by weight, and preferably from 10 to 30% by weight based on the weight of the magnetic powder. In the case where the polyurethane resin or polyisocyanate is used, it is preferred to combine it within the range from 2 to 20% by weight, respectively and use it. However, for example, in the case where head corrosion occurs due to a very small amount of eliminated chlorine, it is possible to use only the polyurethane or only the polyurethane and the polyisocyanate. In the case of using a vinyl chloride based resin as other resin, the addition amount of the vinyl chloride based resin is preferably in the range of from 5 to 30% by weight. In the invention, in the case of using the polyurethane, it is preferable that its glass transition temperature is from −50 to 150° C., and preferably from 0 to 100° C.; that its breaking extension is from 100 to 2,000%; that its breaking stress is from 0.49 to 98 MPa (from 0.05 to 10 kg/mm²); and that its breakdown point is from 0.49 to 98 MPa (from 0.05 to 10 kg/mm²).

For example, in the case where the magnetic recording medium which is used in the invention is a floppy disk, it can be constructed of two or more layers on the both surfaces of a support. Accordingly, as a matter of course, the amount of the binder, the amount of the vinyl chloride based resin, the polyurethane resin, the polyisocyanate or other resins occupied in the binder, the molecular weight of each of the resins for forming the magnetic layer, the amount of the polar group, the physical characteristics of the resins as described above, and the like can be varied in the non-magnetic layer and the respective magnetic layers as the need arises. Rather, they must be optimized for the respective layers, and known technologies regarding multilayered magnetic layers can be applied. For example, in the case where the amount of the binder is changed in the respective layers, it is effective to increase the amount of the binder in the magnetic layer for the sake of reducing scratches on the surface of the magnetic layer. For the sake of making head touch against the head satisfactory, it is possible to bring flexibility by increasing the amount of the binder in the non-magnetic layer.

Examples of the polyisocyanate which can be used in the invention include isocyanates (for example, tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate); reaction products between such an isocyanate and a polyalcohol; and polyisocyanates formed by condensation of such an isocyanate. Among these isocyanates, examples of trade names of commercially available products include CORONATE L, CORONATE HL, CORONATE 2030, CORONATE 2031, MILLIONATE MR, and MILLIONATE MTL (all of which are manufactured by Nippon Polyurethane Industry Co., Ltd.); TAKENATE D-102, TAKENATE D-110N, TAKENATE D-200, and TAKENATE D-202 (all of which are manufactured by Takeda Pharmaceutical Company Limited); and DESMODUR L, DESMODUR IL, DESMODUR N, and DSEMODUR HL (all of which are manufactured by Sumika Bayer Urethane Co., Ltd.). These can be used singly or in combination of two or more kinds thereof while utilizing a difference in the curing reactivity in each layer.

In the magnetic layer in the invention, additives can be added as the need arises. Examples of the additives include an abrasive, a lubricant, a dispersant/dispersing agent, a fungicide, an antistatic agent, an antioxidant, a solvent, and carbon black. Examples of these additives include molybdenum disulfide, tungsten disulfide, graphite, boron nitride, graphite fluoride, silicone oils, polar group-containing silicones, fatty acid-modified silicones, fluorine-containing silicones, fluorine-containing alcohols, fluorine-containing esters, polyolefins, polyglycols, polyphenyl ethers, aromatic ring-containing organic phosphonic acids (for example, phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, toluylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, and nonylphenylphosphonic acid) and alkali metal salts thereof, alkylphosphonic acids (for example, octylphosphonic acid, 2-ethylhexylphosphonic acid, isooctylphosphonic acid, isononylphosphonic acid, isodecylphosphonic acid, isoundecylphosphonic acid, isodecylphosphonic acid, isohexadecylphosphonic acid, isooctadecylphosphonic acid, and isoeicosylphosphonic acid) and alkali metal salts thereof, aromatic phosphoric esters (for example, phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, toluyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate) and alkali metal salts thereof, alkyl phosphates (for example, octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate) and alkali metal salts thereof, alkyl sulfonates and alkali metal salts thereof, fluorine-containing alkyl sulfates and alkali metal salts thereof, monobasic fatty acids having from 10 to 24 carbon atoms, which may contain an unsaturated bond and may be branched (for example, lauric acid, myristic acid, palmitic acid, stearic acid, behenic acid, butyl stearate, oleic acid, lonoleic acid, linolenic acid, elaidic acid, and erucic acid) and metal salts thereof, mono-fatty acid esters, di-fatty acid esters or polyhydric fatty acid esters composed of a monobasic fatty acid having from 10 to 24 carbon atoms, which may have an unsaturated bond and may be branched, any one of a monohydric to hexahydric alcohol having from 2 to 22 carbon atoms, which may have an unsaturated bond and may be braned, an alkoxy alcohol having from 2 to 22 carbon atoms, which may have an unsaturated bond and may be branched, and a monoalkyl ether of an alkylene oxide polymer (for example, butyl stearate, octyl stearate, amyl stearate, isooctyl stearate, octyl myristate, butyl laurate, butoxyethyl stearate, anhydrosorbitan monostearate, and anhydrosorbitan tristearate), fatty acid amides having from 2 to 22 carbon atoms, and aliphatic amines having from 8 to 22 carbon atoms. Also, besides the foregoing hydrocarbon groups, those having an alkyl group, an aryl group, or an aralkyl group substituted with other group than a nitro group and hydrocarbon groups such as halogen-containing hydrocarbons (for example, F, Cl, Br, CF₃, CCl₃, and CBr₃) can be enumerated.

Furthermore, nonionic surfactants (for example, alkylene oxide based surfactants, glycerin based surfactants, glycidol based, and alkylphenol ethylene oxide adducts), cationic surfactants (for example, cyclic amines, ester amides, quaternary ammonium salts, hydantoin derivatives, heterocyclic compounds, phosphonium compounds, and sulfonium compounds), anionic surfactants containing an acidic group (for example, carboxylic acids, sulfonic acids, and sulfuric acid esters), and ampholytic surfactants (for example, amino acids, aminosulfonic acids, sulfuric acid or phosphoric acid esters of an amino alcohol, and alkylbetaine type surfactants) can be used. These surfactants are described in detail in Kaimen Kasseizai Binran (Surfactant Handbook) (published by Sangyo Tosho Publishing).

The foregoing lubricant, lubricant, etc. need not always be pure and may contain, in addition to the major components, impurities such as isomers, unreacted materials, by-products, decomposition products, and oxides. However, the content of these impurities is preferably not more than 30% by weight, and more preferably not more than 10% by weight.

Specific examples of these additives include NAA-102, hardened castor oil fatty acid, NAA-42, CATION SA, NYMEEN L-201, NONION E-208, ANON BF, and ANON LG (all of which manufactured by NOF Corporation); FAL-205 and FAL-123 (all of which are manufactured by Takemoto Oil & Fat Company); ENUJELV OL (manufactured by New Japan Chemical Co., Ltd.); TA-3 (manufactured by Shin-Etsu Chemical Co., Ltd.); ARMIDE P (manufactured by Lion Akzo Co., Ltd.); DUOMIN TDO (manufactured by Lion Corporation); BA-41G (manufactured by The Nisshin Oil Mills, Ltd.); and PROFAN 2012E, NEWPOL PE61, and IONET MS-400 (all of which are manufactured by Sanyo Chemical Industries, Ltd.).

Furthermore, it is possible to add carbon black in the magnetic layer in the invention as the need arises. Examples of the carbon black which can be used in the magnetic layer include furnace black for rubber, thermal black for rubber, carbon black for coloring, and acetylene black. The carbon black preferably has a specific surface area of from 5 to 500 m²/g, aDBP oil absorption of from 10 to 400 mL/100 g, aparticle size of from 5 to 300 mμ, a pH of from 2 to 10, a water content of from 0.1 to 10%, and a tap density of from 0.1 to 1 g/mL.

Specific examples of the carbon black which is used in the invention include BLACKPEARLS 2000, 1300, 1000, 900, 905, 800 and 700 and VULCAN XC-72 (all of which are manufactured by Cabot Corporation); #80, #60, #55, #50, and #35 (all of which are manufactured by Asahi Carbon Co., Ltd.); #2400B, #2300, #900, #1000, #30, #40, and #10B (all of which are manufactured by Mitsubishi Chemical Corporation); CONDUCTEX SC, RAVEN 150, 50, 40 and 15, and RAVEN-MT-P (all of which are manufactured by Columbian Carbon Co.); and Ketjen Black EC (manufactured by Nippon EC K.K.). The carbon black may be subjected to a surface treatment with a dispersant, etc. or grafting with a resin, or a part of the surface of the carbon black may be subjected to graphitization. Also, the carbon black may be dispersed with a binder in advance prior to addition to a magnetic coating material. The carbon black can be used singly or in combination. In the case where the carbon black is used, it is preferred to use the carbon black in an amount of from 0.1 to 30% by weight based on the weight of the magnetic powder. The carbon black has functions of preventing static charging of the magnetic layer, reducing a coefficient of friction, imparting light-shielding properties, and enhancing a film strength. Such functions vary depending upon the type of carbon black to be used. Accordingly, with respect to the carbon black which is used in the invention, it is, as a matter of course, possible to change and choose the type, the amount and the combination for the magnetic layer and the non-magnetic layer according to the intended purpose based on the previously mentioned various characteristics such as particle size, oil absorption, electric conductivity, and pH, and rather, they should be optimized for the respective layers. The carbon black which can be used in the magnetic layer of the invention can be referred to, for example, Kabon Burakku Binran (Carbon Black Handbook) (edited by The Carbon Black Association of Japan).

As an organic solvent which is used in the invention, known organic solvents can be used. As the organic solvent which is used in the invention, a ketone (for example, acetone, methyl ethyl ketone, methyl isobutyl ketone, diisobutyl ketone, cyclohexanone, isophorone, and tetrahydrofuran), an alcohol (for example, methanol, ethanol, propanol, butanol, isobutyl alcohol, isopropyl alcohol, and methylcyclohexanol), an ester (for example, methyl acetate, butyl acetate, isobutyl acetate, isopropyl acetate, ethyl lactate, and glycol acetate), a glycol ether (for example, glycol dimethyl ether, glycol monoethyl ether, and dioxane), an aromatic hydrocarbon (for example, benzene, toluene, xylene, cresol, and chlorobenzene), a chlorohydrocarbon (for example, methylene chloride, ethylene chloride, carbon tetrachloride, chloroform ethylene chlorohydrin, and dichlorobenzene), N,N-dimethylformamide, hexane, or the like can be used at any ratio.

These organic solvents need not always be 100% pure and may contain, in addition to the major components, impurities such as isomers, unreacted materials, by-products, decomposition products, oxides, and moisture. The content of these impurities is preferably not more than 30% by weight, and more preferably not more than 10% by weight. The organic solvent which is used in the invention is preferably the same type for both the magnetic layer and the non-magnetic layer. However, the addition amount of the organic solvent may be varied. When a solvent having a high surface tension (for example, cyclohexanone and dioxane) is used in the non-magnetic layer, the coating stability is enhanced; and more specifically, it is important that an arithmetic mean value of the solvent composition of the upper layer is not lower than an arithmetic mean value of the solvent composition of the non-magnetic layer. In order to enhance the dispersibility, it is preferable that the polarity is somewhat strong, and the solvent composition preferably contains 50% or more of a solvent having a dielectric constant of 15 or more. Also, the solubility parameter is preferably from 8 to 11.

The type and the amount of the dispersant, lubricant and surfactant which are used in the invention can be changed in the magnetic layer and the non-magnetic layer as described later as the need arises. For example, although not limited only to the examples as described herein, the dispersant has properties of adsorbing or bonding via the polar group, and it is assumed that the dispersant adsorbs or bonds, via the polar group, mainly to the surface of the hexagonal ferrite magnetic powder in the magnetic layer and mainly to the surface of the non-magnetic powder in the non-magnetic layer, for example, an organophosphorus compound having been once adsorbed is hardly desorbed from the surface of a metal or metal compound, etc. Accordingly, since in the invention, the surface of the hexagonal ferrite magnetic powder or the surface of the non-magnetic powder is in a state that it is covered by an alkyl group, an aromatic group, etc., the affinity of the hexagonal ferrite magnetic powder or the non-magnetic powder with the binder resin component is enhanced, and further, the dispersion stability of the hexagonal ferrite magnetic powder or the non-magnetic powder is also improved. With respect to the lubricant, since it is present in a free state, its exudation to the surface is controlled by using fatty acids having a different melting point for the non-magnetic layer and the magnetic layer or by using esters having a different boiling point or polarity. The coating stability can be improved by regulating the amount of the surfactant, and the lubricating effect can be enhanced by increasing the amount of the lubricant to be added in the non-magnetic layer. Also, all or a part of the additives which are used in the invention may be added in any stage at the time of preparing a coating solution for magnetic layer or non-magnetic layer. For example, they may be mixed with a ferromagnetic powder prior to the kneading step; they may be added in the kneading step by a ferromagnetic powder, the binder and the solvent; they may be added during the dispersing step; they may be added after the dispersing step; or they may be added immediately before coating.

[Non-Magnetic Layer]

Next, the detail contents regarding the non-magnetic layer will be described below. The magnetic recording medium of the invention can have a non-magnetic layer containing a binder and a non-magnetic powder on the support. The non-magnetic powder which can be used in the non-magnetic layer may be an inorganic substance or an organic substance. Also, carbon black or the like can be used. Examples of the inorganic substance include metals, metal oxides, metal carbonates, metal sulfates, metal nitrides, metal carbides, and metal sulfides.

Specific examples thereof include titanium oxides (for example, titanium dioxide), cerium oxide, tin oxide, tungsten oxide, ZnO, ZrO₂, SiO₂, Cr₂O₃, α-alumina having an α-component proportion of from 90 to 100%, β-alumina, γ-alumina, α-iron oxide, goethite, corundum, silicon nitride, titanium carbide, magnesium oxide, boron nitride, molybdenum disulfide, copper oxide, MgCO₃. CaCO₃, BaCO₃, SrCO₃, BaSO₄, silicon carbide, and titanium carbide. They are used singly or in combination of two or more kinds thereof. Of these, a-iron oxide and titanium oxide are preferable.

The form of the non-magnetic powder may be any one of acicular, spherical, polyhedral, or tabular. A crystallite size of the non-magnetic powder is preferably from 4 nm to 1 μm, and more preferably from 40 to 100 nm. What the crystallite size falls within the range of from 4 nm to 1 μm is preferable because not only the dispersion does not become difficult, but also a suitable surface roughness is obtained. While a mean particle size of such a non-magnetic powder is preferably from 5 nm to 2 μm, it is possible to bring the same effect by combining non-magnetic powders having a different mean particle size, if desired or widening the particle size distribution of even a single non-magnetic powder. The mean particle size of the non-magnetic powder is especially preferably from 10 to 200 nm. What the mean particle size of the non-magnetic powder falls within the range of from 5 nm to 2 μm is preferable because not only dispersion is satisfactory, but also a suitable surface roughness is obtained.

A specific surface area of the non-magnetic powder is from 1 to 100 m²/g, preferably from 5 to 70 m²/g, and more preferably from 10 to 65 m²/g. What the specific surface area falls within the range of from 1 to 100 m²/g is preferable because not only a suitable surface roughness is obtained, but also dispersion can be carried out with a desired amount of the binder. An oil absorption using dibutyl phthalate (DBP) is from 5 to 100 mL/100 g, preferably from 10 to 80 mL/100 g, and more preferably from 20 to 60 mL/100 g. A specific gravity is from 1 to 12, and preferably from 3 to 6. A tap density is from 0.05 to 2 g/mL, and preferably from 0.2 to 1.5 g/mL. When the tap density is in the range of from 0.05 to 2 g/mL, there is little scattering of particles, the operation is easy, and the non-magnetic powder tends to hardly stick to a device. Though a pH of the non-magnetic powder is preferably from 2 to 11, the pH is especially preferably from 6 to 9. When the pH is in the range of from 2 to 11, a coefficient of friction does not become large at a high temperature and a high humidity or by liberation of a fatty acid. A water content of the non-magnetic powder is from 0.1 to 5% by weight, preferably from 0.2 to 3% by weight, and more preferably from 0.3 to 1.5% by weight. What the water content falls within the range of from 0.1 to 5% by weight is preferable because not only dispersion is satisfactory, but also the viscosity of the coating material after dispersion becomes stable. An ignition loss is preferably not more than 20% by weight, and a small ignition loss is preferable.

Furthermore, in the case where the non-magnetic powder is an inorganic powder, its Mohs hardness is preferably from 4 to 10. When the Mohs hardness is in the range of from 4 to 10, it is possible to ensure durability. The non-magnetic powder preferably has an absorption of stearic acid of from 1 to 20 μmoles/m², and more preferably from 2 to 15 μmoles/m². It is preferable that the non-magnetic powder has heat of wetting in water at 25° C. in the range of from 200 to 600 erg/cm² (from 200 to 600 mJ/m²). Also, it is possible to use a solvent whose heat of wetting falls within this range. The number of water molecules on the surface at from 100 to 400° C. is suitably from 1 to 10 per 100 angstrom. The pH at an isolectric point in water is preferably from 3 to 9. It is preferable that Al₂O₃, SiO₂, TiO₂, ZrO₂, SnO₂, Sb₂O₃, or ZnO is present on the surface of the non-magnetic powder through a surface treatment. In particular, Al₂O₃, SiO₂, TiO₂, and ZrO₂ are preferable for the dispersibility, with Al₂O₃, SiO₂ and ZrO₂ being more preferable. They may be used in combination or can be used singly. Furthermore, depending upon the intended purpose, a surface-treated layer resulting from coprecipitation may be used. There may be employed a method in which the surface is first treated with alumina and the surface layer is then treated with silica, or vice versa. Moreover, though the surface-treated layer may be made of a porous layer depending upon the intended purpose, it is generally preferable that the surface treated layer is uniform and dense.

Specific examples of the non-magnetic powder which is used in the non-magnetic layer of the invention include NONATITE (manufactured by Showa Denko K.K.); HIT-100 and ZA-G1 (all of which are manufactured by Sumitomo Chemical Co., Ltd.); DPN-250, DPN-250BX, DPN-245, DPN-270BX, DPB-550BX, and DPN-550RX (all of which are manufactured by Toda Kogyo Corp.); titanium oxides TTO-51B, TTO-55A, TTO-55B, TTO-55C, TTO-55S, TTO-55D, SN-100 and MJ-7 and a-iron oxides E270, E271 and E300 (all of which are manufactured by Ishihara Sangyo Kaisha, Ltd.); STT-4D, STT-30D, STT-30, and STT-65C (all of which are manufactured by Titan Kogyo Kabushiki Kaisha); MT-100S, MT-100T, MT-150W, MT-500B, T-600B, T-100F, and T-500HD (all of which are manufactured by Tayca Corporation); FINEX-25, BF-1, BF-10, BF-20, and ST-M (all of which are manufactured by Sakai Chemical Industry Co., Ltd.); DEFIC-Y and DEFIC-R (all of which are manufactured by Dowa Mining Co., Ltd.); AS2BM and TiO2P25 (all of which are manufactured by Nippon Aerosil Co., Ltd.); 100A and 500A (all of which are manufactured by Ube Industries, Ltd.); and Y-LOP (manufactured by Titan Kogyo Kabushiki Kaisha) and calcined products thereof. Of these, titanium dioxide and α-iron oxide are especially preferable as the non-magnetic powder.

By mixing carbon black with the non-magnetic powder, not only the surface electrical resistance of the non-magnetic layer can be reduced and light transmittance can be decreased, but also a desired micro-Vickers hardness can be obtained. Though the micro-Vickers hardness of the non-magnetic layer is usually from 25 to 60 kg/mm² (from 245 to 588 MPa), for the purpose of adjusting the head contact, it is preferably from 30 to 50 kg/mm² (from 294 to 490 MPa). The micro-Vickers hardness can be measured by using a thin film hardness meter (HMA-400, manufactured by NEC Corporation) with, as an indenter tip, a triangular pyramidal diamond needle having a tip angle of 80° and a tip radius of 0.1 μm. The light transmittance is generally standardized such that absorption of infrared rays having a wavelength of approximately 900 nm is not more than 3% and for example, in the case of VHS magnetic tapes, is not more than 0.8%. For achieving this, furnace black for rubber, thermal black for rubber, carbon black for coloring, acetylene black, and the like can be used.

The carbon black which is used in the non-magnetic layer of the invention has a specific surface area of from 100 to 500 m²/g, and preferably from 150 to 400 m²/g and a DBP oil absorption of from 20 to 400 mL/100 g, and preferably from 30 to 200 mL/100 g. The carbon black has a particle size of from 5 to 80 nm, preferably from 10 to 50 nm, and more preferably from 10 to 40 nm. The carbon black preferably has a pH of from 2 to 10, a water content of from 0.1 to 10%, and a tap density of from 0.1 to 1 g/mL.

Specific examples of the carbon black which can be used in the non-magnetic layer of the invention include BLACKPEARLS 2000, 1300, 1000, 900, 800, 880 and 700 and VULCAN XC-72 (all of which are manufactured by Cabot Corporation); #3050B, #3150B, #3250B, #3750B, #3950B, #950, #650B, #970B, #850B, and MA-600 (all of which are manufactured by Mitsubishi Chemical Corporation); CONDUCTEX SC and RAVEN 8800, 8000, 7000, 5750, 5250, 3500, 2100, 2000, 1800, 1500, 1255 and 1250 (all of which are manufactured by Columbian Carbon Co.); and Ketjen Black EC (manufactured by Akzo Nobel).

Furthermore, those processed by subjecting carbon black to a surface treatment with a dispersant, etc. or grafting with a resin, or by graphitizing a part of the surface thereof may be used. Also, prior to adding carbon black to a coating material, the carbon black may be previously dispersed with a binder. The carbon black can be used within the range not exceeding 50% by weight based on the foregoing inorganic powder and within the range not exceeding 40% by weight of the total weight of the non-magnetic layer. The carbon black can be used singly or in combination. The carbon black which can be used in the non-magnetic layer of the invention can be referred to, for example, Kabon Burakku Binran (Carbon Black Handbook) (edited by The Carbon Black Association of Japan).

Furthermore, it is possible to add an organic powder in the non-magnetic layer depending upon the intended purpose. Examples of such an organic powder include acrylic styrene based resin powders, benzoguanamine resin powders, melamine based resin powders, and phthalocyanine based pigments. Polyolefin based resin powders, polyester based resin powders, polyamide based resin powders, polyimide based resin powders, and polyfluoroethylene resins can also be used. As production methods thereof, those as described in JP-A-62-18564 and JP-A-60-255827 are employable.

With respect to the binder resin, lubricant, dispersant, additives, solvent, dispersion method and others of the non-magnetic layer, those in the magnetic layer can be applied. In particular, with respect to the amount and kind of binder resin and the addition amount and kind of additives and dispersant, known technologies regarding the magnetic layer can be applied.

Furthermore, the magnetic recording medium of the invention may be provided with an undercoat layer. By providing the undercoat layer, it is possible to enhance an adhesive strength between the support and the magnetic layer or non-magnetic layer. As the undercoat layer, a polyester resin which is soluble in a solvent is used.

[Layer Construction]

In the thickness construction of the magnetic recording medium which is used in the invention, a preferred thickness of the support is from 3 to 80 μm. Furthermore, in the case where an undercoat layer is provided between the support and the non-magnetic layer or magnetic layer, a thickness of the undercoat layer is from 0.01 to 0.8 μm, and preferably from 0.02 to 0.6 μm.

Though the thickness of the magnetic layer is optimized according to the saturation magnetization amount and the head gap length of the magnetic head to be used and a band of recording signals, it is generally from 10 to 150 nm, preferably from 20 to 80 nm, and more preferably from 30 to 80 nm. Also, a rate of fluctuation in thickness of the magnetic layer is preferably within ±50%, and more preferably within 40%. The magnetic layer may be made of at least one layer. However, the magnetic layer may be separated into two or more layers having different magnetic characteristics, and a known configuration for multilayered magnetic layers can be applied.

The non-magnetic layer of the invention has a thickness of from 0.5 to 2.0 μm, preferably from 0.8 to 1.5 μm, and more preferably from 0.8 to 1.2 μm. Incidentally, the non-magnetic layer of the magnetic recording medium of the invention exhibits its effect so far as it is substantially non-magnetic. For example, even when it contains a small amount of magnetic substance as an impurity or intentionally, if the effects of the invention can be revealed, such construction can be considered to be substantially the same as that of the magnetic recording medium of the invention. Incidentally, the terms “substantially the same” mean that the non-magnetic layer has a residual magnetic flux density of not more than 10 mT or a coercive force of not more than 7.96 kA/m (100 Oe), and preferably has neither residual flux density nor coercive force.

[Production Method]

A process for producing a coating solution for magnetic layer of the magnetic recording medium which is used in the invention comprises at least a kneading step, a dispersing step, and optionally, a mixing step that is carried out before or after the preceding steps. Each of the steps may be separated into two or more stages. All of the raw materials which are used in the invention, including the hexagonal ferrite magnetic powder, non-magnetic powder, binder, carbon black, abrasive, antistatic agent, lubricant and solvent, may be added in any step from the beginning or in the way of the step. Also, each of the raw materials may be divided and added across two or more steps. For example, a polyurethane may be divided and added in the kneading step, the dispersing step, and the mixing step for adjusting the viscosity after dispersion. In order to achieve the object of the invention, a conventionally known production technology can be employed as a part of the steps. In the kneading step, it is preferred to use a machine having a strong kneading power, such an open kneader, a continuous kneader, a pressure kneader, and an extruder. Details of these kneading treatments are described in JP-A-1-106338 and JP-A-1-79274. Also, for the sake of dispersing a solution for magnetic layer or a solution for non-magnetic layer, glass beads can be used. As such glass beads, dispersing media having a high specific gravity, such as zirconia beads, titania beads, and steel beads, are suitable. These dispersing media are used after optimizing the particle size and packing ratio. Known dispersion machines can be used.

According to the process for producing the magnetic recording medium of the invention, for example, a coating solution for magnetic layer is coated in a prescribed film thickness on the surface of a support under running, thereby forming a magnetic layer. Here, plural coating solutions for magnetic layer may be subjected to multilayer coating sequentially or simultaneously, and a coating solution for non-magnetic layer and a coating solution for magnetic layer may be subjected to multilayer coating sequentially or simultaneously. As a coating machine for coating the foregoing coating solution for magnetic layer or coating layer for non-magnetic layer, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, and the like can be used. With respect to these, for example, Saishin Kothingu Gijutsu (Latest Coating Technologies) (May 31, 1983) (published by Sogo Gijutsu Center) can be referred to.

In the case of a magnetic tape, the coated layer of the coating solution for magnetic layer is subjected to a magnetic field alignment treatment of the hexagonal ferrite magnetic powder contained in the coated layer of the coating solution for magnetic layer in the longitudinal direction by using cobalt magnet or a solenoid. In the case of a disk, although sufficient isotropic alignment can sometimes be obtained in a non-alignment state without using an alignment device, it is preferred to use a known random alignment device by, for example, obliquely and alternately arranging cobalt magnet or applying an alternating magnetic field with a solenoid. The “isotropic alignment” as referred to herein means that, in the case of a hexagonal ferrite magnetic powder, in general, in-plane two-dimensional random is preferable, but it can be three-dimensional random by introducing a vertical component. In the case of a hexagonal ferrite, in general, it tends to be in-plane and vertical three-dimensional random, but in-plane two-dimensional random is also possible. By employing a known method using a heteropolar facing magnet so as to make vertical alignment, it is also possible to impart isotropic magnetic characteristics in the circumferential direction. In particular, in the case of carrying out high-density recording vertical alignment is preferable. Furthermore, it is possible to carry out circumferential alignment using spin coating.

It is preferable that the drying position of the coating film can be controlled by controlling the temperature and blowing amount of dry air and the coating rate. The coating rate is preferably from 20 m/min to 1,000 m/min; and the temperature of the dry air is preferably 60° C. or higher. It is also possible to carry out preliminary drying in a proper level prior to entering a magnet zone.

After drying, the coated layer is usually subjected to a surface smoothing treatment. For the surface smoothing treatment, for example, super calender rolls, etc, are employed. By carrying out the surface smoothing treatment, cavities as formed by removal of the solvent at the time of drying disappear, whereby the packing ratio of the hexagonal ferrite magnetic powder in the magnetic layer is enhanced. Thus, a magnetic recording medium having high electromagnetic conversion characteristics is obtained. As the rolls for calender treatment, rolls of a heat-resistant plastic such as epoxy, polyimide, polyamide, and polyamideimide resins are used. It is also possible to carry out the treatment using metal rolls. It is preferable that the magnetic recording medium of the invention has a surface having extremely excellent smoothness such that a surface center plane average roughness is in the range of from 0.1 to 4 nm and preferably from 1 to 3 nm in a cutoff value of 0.25 mm. As a method therefor, for example, a magnetic layer as formed by selecting a specific hexagonal ferrite magnetic powder and a binder as described above is subjected to the foregoing calender treatment. The calender rolls are preferably actuated under such conditions that the calender roll temperature is in the range of from 60 to 100° C., preferably from 70 to 100° C., and especially preferably from 80 to 100° C.; and that the pressure is in the range of from 100 to 500 kg/cm (from 98 to 490 kN/m), preferably from 200 to 450 kg/cm (from 196 to 441 kN/m), and especially preferably from 300 to 400 kg/cm (from 294 to 392 kN/m).

In the case where the magnetic recording medium of the invention is a magnetic tape, its Hc (in the longitudinal direction) is preferably from 167 to 350 kA/m (more preferably from 180 to 340 kA/m, and especially preferably from 200 to 320 kA/m); its SQ (squareness ratio) is preferably from 0.50 to 0.90 (more preferably from 0.60 to 0.80, and especially preferably from 0.65 to 0.80); and its Bm (maximum magnetic flux density) is preferably from 1,000 to 2,000 mT (more preferably from 1,200 to 2,000 mT, and especially preferably from 1,500 to 2,000 mT).

In the case where the magnetic recording medium of the invention is a magnetic disk, its Hc (in the plane) is preferably from 160 to 350 kA/m (more preferably from 180 to 340 kA/m, and especially preferably from 200 to 320 kA/m); its SQ (squareness ratio) is preferably from 0.40 to 0.60 (more preferably from 0.45 to 0.60, and especially preferably from 0.50 to 0.60); and its Bm (maximum magnetic flux density) is preferably from 1,000 to 2,000 mT (more preferably from 1,200 to 2,000 mT, and especially preferably from 1,500 to 2,000 mT).

The resulting magnetic recording medium can be cut into a desired size by using a cutter, etc. and used. The cutter is not particularly limited, but one in which a plurality of pairs of rotating upper blade (male blade) and lower blade (female blade) are provided is preferable. A slit speed, a working depth, a circumferential speed ratio of upper blade (male blade) and lower blade (female blade) {(upper blade circumferential speed)/(lower blade circumferential speed)}, a period of time of continuous use of slit blades, and so on are properly selected.

[Physical Properties]

A coefficient of friction of the magnetic recording medium which is used in the invention against a head is not more than 0.5, and preferably not more than 0.3 at a temperature in the range of from −10 to 40° C. and at a humidity in the range of from 0 to 95%. A surface specific resistivity is preferably from 10⁴ to 10¹² Ω/sq on the magnetic surface; and an electrostatic potential is preferably from −500 V to +500 V. The magnetic layer preferably has a modulus of elasticity at an elongation of 0.5% of from 0.98 to 19.6 GPa (from 100 to 2,000 kg/mm²) in each direction within the plane and preferably has a breaking strength of from 98 to 686 MPa (from 10 to 70 kg/mm²); and the magnetic recording medium preferably has a modulus of elasticity of from 0.98 to 14.7 GPa (from 100 to 1,500 kg/mm²) in each direction within the plane, preferably has a residual elongation of not more than 0.5%, and preferably has a thermal shrinkage at any temperature of not higher than 100° C. of not more than 1%, more preferably not more than 0.5%, and most preferably not more than 0.1%.

The magnetic layer preferably has a glass transition temperature (the maximum point of a loss elastic modulus in a dynamic viscoelasticity measurement at 110 Hz) of from 50 to 180° C.; and the non-magnetic layer preferably has a glass transition temperature of from 0 to 180° C. The loss elastic modulus is preferably in the range of from 1×10⁷ to 8×10⁸ Pa (from 1×10⁸ to 8×10⁹ dyne/cm²); and a loss tangent is preferably not more than 0.2. When the loss tangent is too large, a sticking fault likely occurs. It is preferable that these thermal characteristics and mechanical characteristics are substantially identical within 10% in each direction in the plane of the medium.

The residual solvent to be contained in the magnetic layer is preferably not more than 100 mg/m², and more preferably not more than 10 mg/m². A porosity of the coated layer is preferably not more than 30% by volume, and more preferably not more than 20% by volume in both the non-magnetic layer and the magnetic layer. In order to achieve a high output, the porosity is preferably small, but there is some possibility that a certain value should be maintained depending upon the intended purpose. For example, in the case of a disk medium where repetitive use is considered to be important, a large porosity is often preferable in view of running durability.

It is preferable that the magnetic layer has a maximum height SRₘₐₓ of not more than 0.5 μm, a ten-point average roughness SRz of not more than 0.3 μm, a central surface peak height SRp of not more than 0.3 μm, a central surface valley depth SRv of not more than 0.3 μm, a central surface area factor SSr of from 20 to 80%, and an average wavelength Sλa of from 5 to 300 μm. These properties can be easily controlled by controlling the surface properties of the support by a filler, the shape of the roll surface in the calender treatment, and so on. It is preferable that the curl is within ±3%.

In the case where the magnetic recording medium of the invention is constructed of the non-magnetic layer and the magnetic layer, it is possible to vary these physical characteristics in the non-magnetic layer and the magnetic layer depending upon the intended purpose. For example, by increasing the modulus of elasticity of the magnetic layer, thereby enhancing the durability, it is possible to simultaneously make the modulus of elasticity of the non-magnetic layer lower than that of the magnetic layer, thereby improving the head contact of the magnetic recording medium.

### EXAMPLES

The invention will be further described below with reference to the following Examples and Comparative Examples, but it should not be construed that the invention is limited to these examples. Incidentally, all parts are a part by weight.

### Examples 1 to 8 and Comparative Examples 1 to 5

<Preparation of Hexagonal Ferrite Magnetic Powder>

In order to obtain a composition consisting of 31% by mole of BaO, 31% by mole of B₂O₃, and 38% by mole of a Ba ferrite component represented by the composition formula: BaO.Fe_{12-(3(x+y)+z)/2}CoₓZn_{y}M_{z}Nb_{(x+y-z)2}O₁₈ (wherein M representes a tetravalent element), raw materials corresponding to the respective elements were weighed and thoroughly mixed. The raw material mixture was charged in a platinum crucible and melted under heating at 1,350° C. by using a high-frequency heating unit. After melting all of the raw materials, the molten mixture was stirred for one hour such that it became homogenous, and the homogenous melt was poured on water cooled double rolls as rotated at a high speed and roll quenched, thereby preparing an amorphous material. The resulting amorphous material was kept at a prescribed crystallization temperature for 5 hours in a thermal treatment furnace, thereby depositing a Ba ferrite crystal. Thereafter, the deposit was pulverized and subjected to an acid treatment in a 10% acetic acid solution with stirring for 4 hours while controlling the solution temperature at 80° C. or higher, thereby dissolving BaO and B₂O₃ therein. Subsequently, in order to remove these BaO and B₂O₃ components and acid component, water washing was thoroughly repeated. Finally, the resulting slurry was dried to obtain a magnetic powder. Characteristics of the resulting magnetic powder are shown in Table 1 along with the composition components. Incidentally, with respect to the average tabular diameter and average tabular thickness, a photograph of particles with a magnification of 400,000 times as captured by a transmission electron microscope was measured, and the tabular diameter and tabular thickness with respect to 300 particles whose side planes could be seen were measured, from which were then determined average values thereof. Furthermore, the average tabular ratio was defined as an arithmetic mean value of {(tabular diameter)/(tabular thickness)}. The magnetic characteristics (Hc and SFD) were measured at 23° C. in an applied magnetic field of 10 kOe by using a vibration sample magnetometer (manufactured by Toei Industry Co., Ltd.).

TABLE 1

| | | | | | | Atomic number | |
|---|---|---|---|---|---|---|---|
| | Content of element | | | | | of M based on | Crystallization |
| | Tetravalent element | | Zn | Co | Nb | one atom of Fe | temperature |
| | M | z | y | x | (x + y − z)/2 | Atom | ° C. |
| Example 1 | Zr | 0.12 | 0.32 | 0.12 | 0.16 | 0.011 | 660 |
| Example 2 | Zr | 0.24 | 0.24 | 0.12 | 0.06 | 0.021 | 660 |
| Example 3 | Zr | 0.44 | 0.44 | 0.00 | 0.00 | 0.040 | 660 |
| Example 4 | Zr | 0.12 | 0.24 | 0.12 | 0.12 | 0.011 | 610 |
| Example 5 | Zr | 0.12 | 0.24 | 0.12 | 0.12 | 0.011 | 660 |
| Example 6 | Zr | 0.12 | 0.00 | 0.12 | 0.00 | 0.010 | 660 |
| Example 7 | Zr | 0.24 | 0.12 | 0.12 | 0.00 | 0.021 | 660 |
| Example 8 | Sn | 0.24 | 0.12 | 0.12 | 0.00 | 0.021 | 660 |
| Comparative | O | 0 | 0.35 | 0.12 | 0.24 | 0.000 | 660 |
| Example 1 | | | | | | | |
| Comparative | Zr | 0.54 | 0.44 | 0.12 | 0.01 | 0.050 | 660 |
| Example 2 | | | | | | | |
| Comparative | Zr | 0.12 | 0.12 | 0.36 | 0.18 | 0.011 | 660 |
| Example 3 | | | | | | | |
| Comparative | Zr | 0.12 | 0.24 | 0.12 | 0.12 | 0.011 | 590 |
| Example 4 | | | | | | | |
| Comparative | Zr | 0.24 | 0.12 | 0.12 | 0.00 | 0.021 | 700 |
| Example 5 | | | | | | | |

| | Average tabular | Average tabular | | | | |
|---|---|---|---|---|---|---|
| | diameter | thickness | Average tabular | Hc | | |
| | nm | nm | ratio | Oe | kA/m | SFD |
| Example 1 | 22 | 7.3 | 3.1 | 2300 | 184 | 0.63 |
| Example 2 | 25 | 7.8 | 3.2 | 2100 | 168 | 0.55 |
| Example 3 | 30 | 6.3 | 4.8 | 2300 | 184 | 0.37 |
| Example 4 | 18 | 5.6 | 3.2 | 2050 | 164 | 0.68 |
| Example 5 | 25 | 6.3 | 4.0 | 3500 | 280 | 0.41 |
| Example 6 | 27 | 6.4 | 4.2 | 4000 | 320 | 0.34 |
| Example 7 | 29 | 6.6 | 4.4 | 2800 | 224 | 0.40 |
| Example 8 | 26 | 7.8 | 3.3 | 3150 | 252 | 0.48 |
| Comparative | 20 | 7.3 | 2.8 | 2150 | 172 | 0.84 |
| Example 1 | | | | | | |
| Comparative | 30 | 5.6 | 5.4 | 2100 | 168 | 0.38 |
| Example 2 | | | | | | |
| Comparative | 21 | 6.6 | 3.2 | 1800 | 144 | 1.00 |
| Example 3 | | | | | | |
| Comparative | 14 | 4.7 | 3.0 | 1200 | 96 | 1.80 |
| Example 4 | | | | | | |
| Comparative | 33 | 7.2 | 4.6 | 3200 | 256 | 0.40 |
| Example 5 | | | | | | |

<Preparation of Coating Material for Tape>

Coating Material for Forming a Magnetic Layer

| | | |
|---|---|---|
| Barium ferrite magnetic powder: | 100 | parts |
| Polyurethane resin: | 12 | parts |
| Weight average molecular weight: 10,000 | | |
| Sulfonic acid functional group: 0.5 meq/g | | |
| α-Alumina: | 8 | parts |
| HIT60 (manufactured by Sumitomo Chemical Co., Ltd.) | | |
| Carbon black (particle size: 0.015 μm): | 0.5 | parts |
| #55 (manufactured by Asahi Carbon Co., Ltd.) | | |
| Stearic acid: | 0.5 | parts |
| Butyl stearate: | 2 | parts |
| Methyl ethyl ketone: | 180 | parts |
| Cyclohexanone: | 100 | parts |

Coating Material for Forming a Non-Magnetic Layer

| | | |
|---|---|---|
| Non-magnetic powder, α-iron oxide: | 100 | parts |
| Average long axis length: 0.09 μm | | |
| Specific surface area as measured by the BET | | |
| method: 50 m²/g | | |
| pH: 7 | | |
| DBP oil absorption: 27 to 38 mL/100 g | | |
| Surface-treated layer, Al₂^{O}₃: 8% by weight | | |
| Carbon black: | 25 | parts |
| CONDUCTEX SC-U (manufactured by | | |
| Columbian Carbon Co.) | | |
| Vinyl chloride copolymer: | 13 | parts |
| MR104 (manufactured by Zeon Corporation) | | |
| Polyurethane resin: | 5 | parts |
| UR8200 (manufactured by Toyobo Co., Ltd.) | | |
| Phenylphosphonic acid: | 3.5 | parts |
| Butyl stearate: | 1 | part |
| Stearic acid: | 2 | parts |
| Methyl ethyl ketone: | 205 | parts |
| Cyclohexanone: | 135 | parts |

<Preparation of Magnetic Tape>

With respect to each of the foregoing coating materials, the respective components were kneaded by a kneader. The kneaded mixture was fed into a lateral sand mill charged with 1.0-mmφ zirconia beads in an amount of 65% by volume based on the volume of the dispersing portion by means of a pump and dispersed at 2,000 rpm for 120 minutes (a period of time at which the mixture was substantially retained). With respect to the resulting dispersion, 5.0 parts of a polyisocyanate was added to the coating material for non-magnetic layer, and 2.5 parts of a polyisocyanate was added to the coating material for magnetic layer, respectively. For the coating material for magnetic layer, 3 parts of methyl ethyl ketone was further added. Each of the mixtures was filtered by a filter having a mean pore size of 1 μm, thereby preparing a coating solution for forming a non-magnetic layer and a coating solution for forming a magnetic layer, respectively.

The resulting coating solution for forming a non-magnetic layer was coated on a 4 μm-thick polyethylene terephthalate base in a thickness after drying of 1.5 μm and dried. Thereafter, the coating solution for forming a magnetic layer was subjected to sequential multilayer coating in a thickness of the magnetic layer of 0.10 μm. During a period of time at which the magnetic layer was still in a wet state, the coated material was aligned by using a cobalt magnet having a magnetic force of 6,000 G (600 mT) and a solenoid having a magnetic force of 6,000 G and then dried. Next, the resulting coated material was subjected to 7-stage calendaring at a temperature of 90° C. and at a linear pressure of 300 kg/cm (294 kN/m). Thereafter, a 0.5 μm-thick back layer (a dispersion as prepared by dispersing 100 parts of carbon black (mean particle size: 17 nm), 80 parts of calcium carbonate (mean particle size: 40 nm) and 5 parts of α-alumina (mean particle size: 200 nm) in a nitrocellulose resin, a polyurethane resin and a polyisocyanate) was coated. The resulting coated material was slit into a width of 3.8 mm; a non-woven fabric and a razor blade were mounted on a device provided with a feeding and winding unit of slit article so as to come into contact with the magnetic surface; and the surface of the magnetic layer was cleaned by using a tape cleaning unit, thereby obtaining a magnetic tape medium.

With respect to the resulting magnetic tape medium, the magnetic characteristics were examined in the same manner as described above. Furthermore, an output and a noise were examined. These were measured by using a drum tester mounted with a recording head (MIG, gap: 0.15 μm, 1.8 T) and a reproducing GMR head. A head-medium relative speed was set up at 15 m/sec. The noise was measured with respect to modulation noise. SN was shown while taking SN of Comparative Example 1 as 0 dB.

The results are shown in Table 2. Incidentally, the Example and Comparative Example numbers in Table 2 are corresponding to the Example and Comparative Example numbers of magnetic powder as shown in Table 1.

TABLE 2

| | Hc | | | | Bm | Output | Noise | S/N |
|---|---|---|---|---|---|---|---|---|
| Example | Oe | kA/m | SQ | SFD | mT | dB | dB | dB |
| Example 1 | 2449 | 196 | 0.62 | 0.42 | 148.8 | 2.3 | 0.5 | 1.8 |
| Example 2 | 2243 | 179 | 0.68 | 0.38 | 150.1 | 2.6 | 1.1 | 1.5 |
| Example 3 | 2449 | 196 | 0.78 | 0.29 | 145.0 | 2.7 | 1.2 | 1.5 |
| Example 4 | 2192 | 175 | 0.54 | 0.44 | 150.0 | 1.3 | −0.3 | 1.6 |
| Example 5 | 3685 | 295 | 0.68 | 0.31 | 134.1 | 2.5 | 1.2 | 1.3 |
| Example 6 | 4200 | 336 | 0.72 | 0.27 | 132.2 | 2.5 | 1.5 | 1.0 |
| Example 7 | 2964 | 237 | 0.76 | 0.3 | 130.3 | 3.0 | 1.6 | 1.4 |
| Example 8 | 3325 | 266 | 0.7 | 0.34 | 149.1 | 2.6 | 1.2 | 1.4 |
| Comparative | 2295 | 184 | 0.58 | 0.52 | 152.7 | 0.0 | 0.0 | 0.0 |
| Example 1 | | | | | | | | |
| Comparative | 2243 | 179 | 0.78 | 0.29 | 111.4 | −0.6 | 1.9 | −2.6 |
| Example 2 | | | | | | | | |
| Comparative | 1934 | 155 | 0.6 | 0.6 | 145.8 | −1.6 | 0.0 | −1.7 |
| Example 3 | | | | | | | | |
| Comparative | 1316 | 105 | 0.46 | 1 | 142.3 | −6.5 | −1.8 | −4.6 |
| Example 4 | | | | | | | | |
| Comparative | 3376 | 270 | 0.84 | 0.3 | 130.6 | 1.8 | 2.8 | −1.0 |
| Example 5 | | | | | | | | |

<Results of Evaluation of Magnetic Tape Medium>

From the results as shown in Tables 1 and 2, it is noted that in the magnetic powders of the invention, even when the tabular diameter is small, the increase of SFD is suppressed as compared with those of the Comparative Examples. It is also noted that the magnetic powders of the invention exhibit satisfactory output characteristics and low noise properties.

Next, a magnetic disk medium containing the hexagonal ferrite magnetic powder of the invention in a magnetic layer was prepared.

<Preparation of Coating Material for Disk>

Magnetic Coating Material for Forming a Magnetic Layer

| | | |
|---|---|---|
| Barium ferrite magnetic powder: | 100 | parts |
| Polyurethane resin: | 12 | parts |
| Weight average molecular weight: 10,000 | | |
| Sulfonic acid functional group: 0.5 meq/g | | |
| Diamond fine particle: | 2 | parts |
| Mean particle size: 0.10 μm | | |
| Carbon black (particle size: 0.015 μm): | 0.5 | parts |
| #55 (manufactured by Asahi Carbon Co., Ltd.) | | |
| Stearic acid: | 0.5 | parts |
| Butyl stearate: | 2 | parts |
| Methyl ethyl ketone: | 230 | parts |
| Cyclohexanone: | 150 | parts |

Coating Material for Forming a Non-Magnetic Layer

| | | |
|---|---|---|
| Non-magnetic powder, α-iron oxide: | 100 | parts |
| Average long axis length: 0.09 μm | | |
| Specific surface area as measured by the BET | | |
| method: 50 m²/g | | |
| pH: 7 | | |
| DBP oil absorption: 27 to 38 mL/100 g | | |
| Surface-treated layer, Al₂O₃: 8% by weight | | |
| Carbon black: | 25 | parts |
| CONDUCTEX SC-U (manufactured by | | |
| Columbian Carbon Co.) | | |
| Vinyl chloride copolymer: | 13 | parts |
| MR104 (manufactured by Zeon Corporation) | | |
| Polyurethane resin: | 5 | parts |
| UR8200 (manufactured by Toyobo Co., Ltd.) | | |
| Phenylphosphonic acid: | 3.5 | parts |
| Butyl stearate: | 1 | part |
| Stearic acid: | 2 | parts |
| Methyl ethyl ketone: | 205 | parts |
| Cyclohexanone: | 135 | parts |

<Preparation of Magnetic Disk Medium>

With respect to each of the foregoing coating materials, the respective components were kneaded by a kneader. The kneaded mixture was fed into a lateral sand mill charged with 1.0-mmφ zirconia beads in an amount of 65% by volume based on the volume of the dispersing portion by means of a pump and dispersed at 2,000 rpm for 120 minutes (a period of time at which the mixture was substantially retained). With respect to the resulting dispersion, 6.5 parts of a polyisocyanate was added to the coating material for non-magnetic layer, and 2.5 parts of a polyisocyanate was added to the coating material for magnetic layer, respectively. For the coating material for magnetic layer, 7 parts of methyl ethyl ketone was further added. Each of the mixtures was filtered by a filter having a mean pore size of 1 μm, thereby preparing a coating solution for forming a non-magnetic layer and a coating solution for forming a magnetic layer, respectively.

The resulting coating solution for forming a non-magnetic layer was coated on a 62 μm-thick polyethylene terephthalate base in a thickness after drying of 1.5 μm and dried. Thereafter, the coating solution for forming a magnetic layer was subjected to sequential multilayer coating in a thickness of the magnetic layer of 0.10 atm. After drying, the coated material was subjected to 7-stage calendaring at a temperature of 90° C. and at a linear pressure of 300 kg/cm. These operations were applied to the both surfaces of a non-magnetic support. The resulting coated material was punched into a size of 3.5 inches and subjected to a surface abrasion treatment to obtain a magnetic disk medium.

With respect to the resulting magnetic disk medium, the magnetic characteristics and noise were examined in the same manner as in the magnetic tape medium. Incidentally, with respect to the output and noise, a recording head (MIG, gap: 0.15 μm, 1.8 T) and a reproducing GMR head were mounted on a spin stand and provided for measurement. The number of revolution of the medium and the recording wavelength were set up at 4,000 rpm and 0.2 μm, respectively. With respect to the noise, a modulation noise was measured. SN was shown while taking SN of Comparative Example 1 as 0 dB.

The results are shown in Table 2. Incidentally, the Example and Comparative Example numbers in Table 2 are corresponding to the Example and Comparative Example numbers of magnetic powder as shown in Table 1.

TABLE 3

| | Hc | | | | Bm | Output | Noise | S/N |
|---|---|---|---|---|---|---|---|---|
| Example | Oe | kA/m | SQ | SFD | mT | dB | dB | dB |
| Example 1 | 2240 | 179 | 0.51 | 0.64 | 148.8 | 1.9 | 0.5 | 1.4 |
| Example 2 | 2080 | 166 | 0.5 | 0.45 | 150.1 | 2.7 | 1.3 | 1.4 |
| Example 3 | 2240 | 179 | 0.51 | 0.27 | 123.4 | 3.5 | 2.3 | 1.3 |
| Example 4 | 2040 | 163 | 0.5 | 0.58 | 142.6 | 0.8 | −0.3 | 1.1 |
| Example 5 | 3200 | 256 | 0.56 | 0.31 | 134.1 | 4.1 | 1.4 | 2.7 |
| Example 6 | 3600 | 288 | 0.57 | 0.24 | 132.2 | 5.1 | 1.9 | 3.2 |
| Example 7 | 2640 | 211 | 0.54 | 0.3 | 130.3 | 3.4 | 2.1 | 1.2 |
| Example 8 | 2920 | 234 | 0.55 | 0.38 | 149.1 | 4.2 | 1.6 | 2.5 |
| Comparative | 2120 | 170 | 0.51 | 0.74 | 152.7 | 0 | 0 | 0 |
| Example 1 | | | | | | | | |
| Comparative | 2080 | 166 | 0.5 | 0.28 | 111.4 | 1.7 | 2.2 | −0.5 |
| Example 2 | | | | | | | | |
| Comparative | 1840 | 147 | 0.48 | 0.9 | 145.8 | −2.4 | 0 | −2.3 |
| Example 3 | | | | | | | | |
| Comparative | 1360 | 109 | 0.4 | 1.7 | 142.3 | −5 | −2.3 | −2.7 |
| Example 4 | | | | | | | | |
| Comparative | 2960 | 237 | 0.55 | 0.3 | 130.6 | 3.7 | 3.3 | 0.4 |
| Example 5 | | | | | | | | |

<Results of Evaluation of Magnetic Disk Medium>

From the results as shown in Table 3, it is noted that in the magnetic powders of the invention, even when the tabular diameter is small, the increase of SFD is suppressed as compared with those of the Comparative Examples. It is also noted that the magnetic powders of the invention exhibit satisfactory output characteristics and low noise properties.

This application is based on Japanese Patent application JP 2004-182593, filed Jun. 21, 2004, the entire content of which is hereby incorporated by reference, the same as if set forth at length.

1. A hexagonal ferrite magnetic powder having an average tabular diameter of from 15 to 30 nm, an average tabular ratio of from 3.0 to 4.9, an Hc of from 2,020 to 5,000 Oe (from 161.6 to 400 kA/m) and an SFD of from 0.3 to 0.7, and comprising at least one tetravalent element in a proportion of from 0.004 to 0.045 atoms based on one atom of Fe.

2. The hexagonal ferrite magnetic powder according to claim 1, wherein the tetravalent element is at least one member selected from the group consisting of Ti, Mn, Zr, Sn, Hf, Ir, Ce and Pb.

3. The hexagonal ferrite magnetic powder according to claim 1, wherein the tetravalent element is at least one member selected from the group consisting of Zr and Sn.

4. The hexagonal ferrite magnetic powder according to claim 1, further comprising at least one divalent element selected from the group consisting of Mg, Co, Ni, Cu, Zn, Pd and Cd in a proportion of from 0.004 to 0.045 atoms based on one atom of Fe.

5. The hexagonal ferrite magnetic powder according to claim 1, further comprising at least one divalent element selected from the group consisting of Mg, Co, Ni, Cu, Zn, Pd and Cd in a proportion of from 0.010 to 0.035 atoms based on one atom of Fe.

6. The hexagonal ferrite magnetic powder according to claim 1, further comprising at least one divalent element selected from the group consisting of Co and Zn in a proportion of from 0.004 to 0.045 atoms based on one atom of Fe.

7. The hexagonal ferrite magnetic powder according to claim 1, which comprises at least one tetravalent element in a proportion of from 0.010 to 0.035 atoms based on one atom of Fe.

8. The hexagonal ferrite magnetic powder according to claim 1, which has an average tabular diameter of from 18 to 28 nm.

9. The hexagonal ferrite magnetic powder according to claim 1, which has an average tabular ratio of from 3.0 to 4.2.

10. The hexagonal ferrite magnetic powder according to claim 1, which has an Hc of from 2,100 to 4,200 Oe (from 168 to 336 kA/m).

11. The hexagonal ferrite magnetic powder according to claim 1, which has an SFD of from 0.3 to 0.6.

12. A process for producing the hexagonal ferrite magnetic powder according to claim 1, which comprises:
mixing hexagonal ferrite forming raw materials with at least one tetravalent element in a proportion of from 0.004 to 0.045 atoms based on one atom of Fe contained in the hexagonal ferrite forming raw materials to obtain a mixture;
melting the mixture;
quenching the molten mixture to obtain an amorphous material; and
thermally treating the amorphous material to deposit a hexagonal ferrite.

13. The process according to claim 12, wherein the tetravalent element is at least one member selected from the group consisting of Ti, Mn, Zr, Sn, Hf, Ir, Ce and Pb.

14. A magnetic recording medium comprising:
a non-magnetic support; and
a magnetic layer containing a hexagonal ferrite magnetic powder according to claim 1 and a binder.

15. The magnetic recording medium according to claim 14, further comprising a non-magnetic layer between the non-magnetic support and the magnetic layer, the non-magnetic layer containing non-magnetic powder and a binder.
